(19) United States
(12) Patent Application Publication
(10) Pub. No.: US 2025/0112396 A1
(43) Pub. Date: Apr. 3, 2025

(54) CONNECTOR

(71) Applicant: SUMITOMO WIRING SYSTEMS, LTD., Mie (JP)

(72) Inventors: Ryuta TAKAHASHI, Mie (JP); Yukihiro FUKATSU, Mie (JP); Shingo TAJIMA, Mie (JP)

(21) Appl. No.: 18/897,626

(22) Filed: Sep. 26, 2024

(30) Foreign Application Priority Data
Sep. 28, 2023 (JP) 2023-166672

(51) Int. Cl. H01R 13/436

(52) U.S. Cl. CPC H01R 13/4362

(57) ABSTRACT

A connector includes a housing, a conductive member, female terminals connected to a connecting portion of the conductive member, and retainers. The conductive member includes a first cover portion and a second cover portion that cover a front surface of the housing. The housing includes lances for engaging the female terminals, deflection allowance spaces for allowing the lances to deflect therein, wall portions formed on side surfaces that intersect the front surface and define the deflection allowance spaces between the lances and the wall portions, mounting holes open in the side surfaces rearward of the wall portions, and through holes open in the side surfaces forward of the wall portions. The retainers include engagement portions disposed in the mounting holes for engaging the female terminals in the full engagement position. Each lance has a release surface disposed to be oriented toward the through hole.

### CROSS-REFERENCE TO RELATED APPLICATIONS

This application is based on and claims priority from Japanese Patent Application No. 2023-166672, filed on Sep. 28, 2023, with the Japan Patent Office, the disclosure of which is incorporated herein in its entirety by reference.

### TECHNICAL FIELD

The present disclosure relates to a connector.

### BACKGROUND

JP 2011-103193 A discloses a joint connector having a joint terminal (hereinafter referred to as “conductive member” for the sake of convenience) that is fastened to a vehicle with a bolt. This joint connector is provided with lances that engage with female terminals inserted from behind. The housing of the joint connector has formed in the front surface thereof jig insertion grooves from which the conductive member is extended. A jig is inserted into each jig insertion groove from the front to disengage the lance from the female terminal. A bracket protruding forward from the housing of the conductive member is bent downward and configured to cover a portion (a lower portion) of the front surface of the housing from the front.

### SUMMARY

Depending on the shape of the conductive member that covers the front surface of the housing, it may be difficult to insert the jig from the front of the housing (the side on which the joint terminal is located) to disengage the lances.

In view of the above problem, an object of the present disclosure is to provide a connector that allows for the release of the engagement of lances without being affected by the shape of the conductive member.

A connector according to the present disclosure includes: a housing; a conductive member mounted to a front portion of the housing; a terminal received in a rear portion of the housing for connection with a connecting portion of the conductive member; and a retainer movably disposed between a provisional engagement position and a full engagement position with respect to the housing; wherein the conductive member includes a cover portion covering at least a part of a front surface of the housing; wherein the housing includes a lance capable of elastic deformation for primarily engaging the terminal, a deflection allowance space for allowing the lance to deflect therein; a wall portion formed on a side surface that intersects the front surface and defines the deflection allowance space between the lance and the wall portion, a mounting hole open in the side surface in a rear of the wall portion, and a through hole open in the side surface forward of the wall portion; wherein the retainer includes an engagement portion disposed in the mounting hole for secondarily engaging the terminal in the full engagement position; and wherein the lance includes a release surface disposed to be oriented toward the through hole.

According to the present disclosure, the engagement of a lance of a connector can be released without being affected by the shape of a conductive member.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view showing a connector of a first embodiment.

FIG. 2 is a perspective view showing a housing.

FIG. 3 is a side cross-sectional view of the housing.

FIG. 4 is a perspective view showing a conductive member.

FIG. 5 is a side cross-sectional view of the connector.

FIG. 6 is a perspective view showing a retainer.

FIG. 7 is a side view of the connector with the retainers disposed in a provisional engagement position.

FIG. 8 is a side view of the connector with the retainers disposed in a full engagement position.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

(1) A connector including: a housing; a conductive member mounted to a front portion of the housing; a terminal received in a rear portion of the housing for connection with a connecting portion of the conductive member; and a retainer movably disposed between a provisional engagement position and a full engagement position with respect to the housing; wherein the conductive member includes a cover portion covering at least a part of a front surface of the housing; wherein the housing includes a lance capable of elastic deformation for primarily engaging the terminal, a deflection allowance space for allowing the lance to deflect therein; a wall portion formed on a side surface that intersects the front surface and defines the deflection allowance space between the lance and the wall portion, a mounting hole open in the side surface in a rear of the wall portion, and a through hole open in the side surface forward of the wall portion; wherein the retainer includes an engagement portion disposed in the mounting hole for secondarily engaging the terminal in the full engagement position; and wherein the lance includes a release surface disposed to be oriented toward the through hole.

In the connector of (1), as a through hole can be formed to be open on a side surface, the lance can be manipulated with a jig via the through hole, even if the conductive member is configured to cover the front surface of the housing so that the jig cannot be inserted from the front surface. Moreover, as the through hole and the mounting hole are open in the side surface intersecting the front surface, the through hole and the mounting hole can be both formed using a single slide core of the mold without requiring a complicated mold structure.

(2) The connector of (1), wherein the retainer includes an eave portion extending forward from the engagement portion, and the eave portion closes the through hole in the full engagement position and opens the through hole in the provisional engagement position.

With the connector of (2), it is possible to limit and permit the release of the engagement of the lances.

(3) The connector of (2), wherein the retainer moves rearward from the full engagement position to the provisional engagement position.

In the connector of (3), with the retainer in the provisional engagement position, the eave portion can leave open a front portion of the through hole, facilitating the insertion of the jig into the through hole in a direction that intersects the front-rear direction.

(4) The connector of any one of (1)-(3), wherein the through hole has an evacuation surface forward of the release surface, the evacuation surface sloping forward as the evacuation surface approaches the opening in the side surface.

In the connector of (4), the evacuation surface provides a freedom in the manner in which the jig is inserted into the through hole. Moreover, the jig can act on the release surface without interference with the evacuation surface.

### Details of Embodiments of Present Disclosure

### First Embodiment

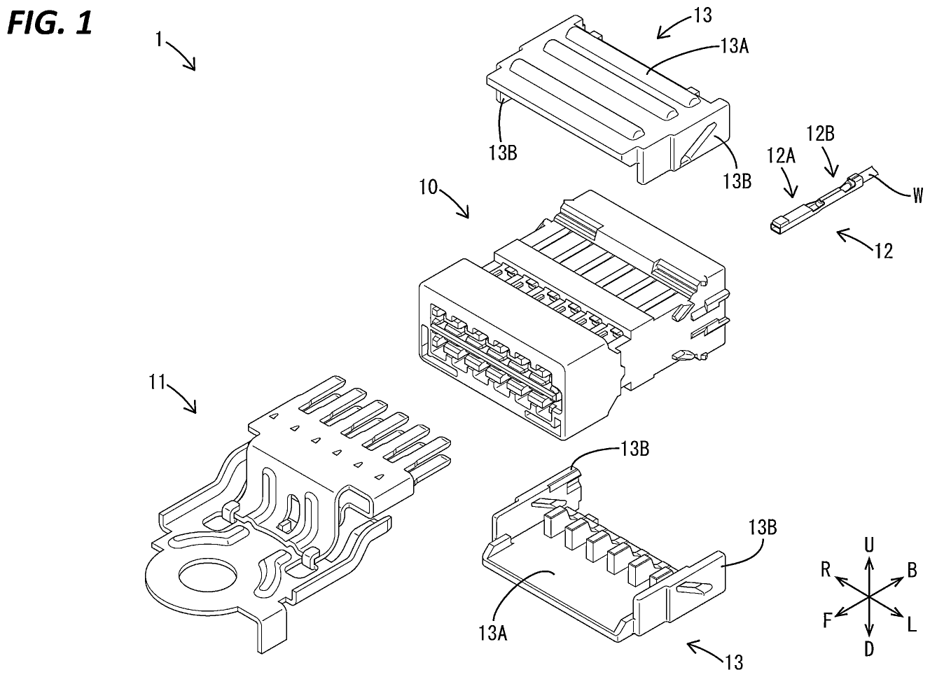

A first embodiment that embodies a connector 1 of the present disclosure will be described with reference to FIGS. 1 to 8. In the drawings, “front side,” “back side,” “upper side,” “lower side,” “right side,” and “left side” are denoted by “F,” “B,” “U,” “D,” “R,” and “L,” respectively. It should be noted that these reference directions are provided for convenience and do not necessarily coincide with the directions in the state where the connector 1 is mounted on a vehicle or the like. For example, the up-down direction is not limited to the direction of gravity.

### [Configuration of Connector]

As shown in FIG. 1, the connector 1 has a housing 10, a conductive member 11, terminals or female terminals 12, and two retainers 13.

### [Configuration of Housing]

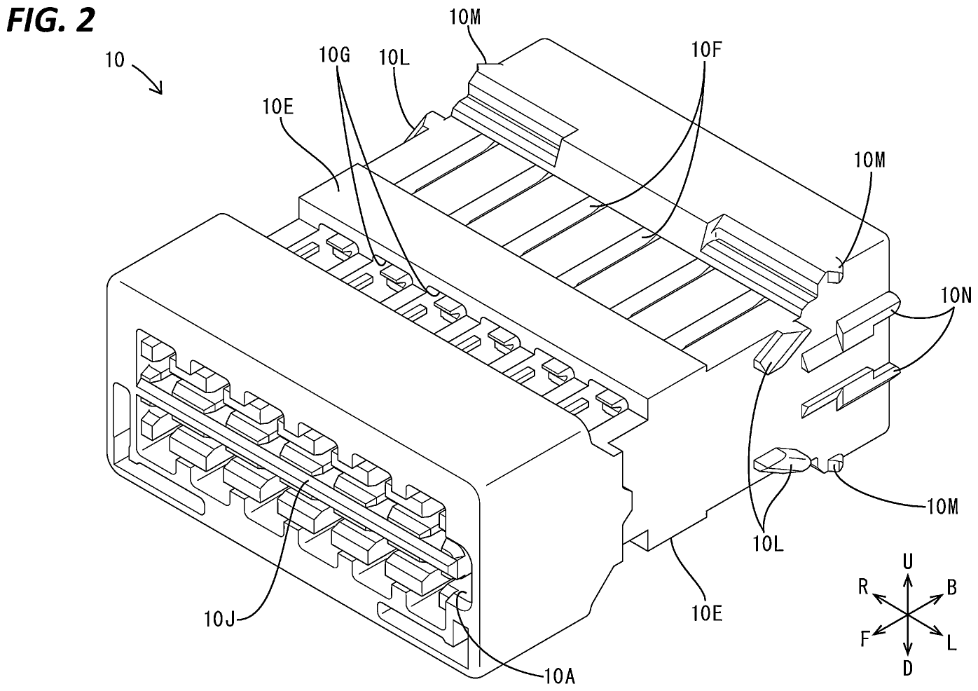

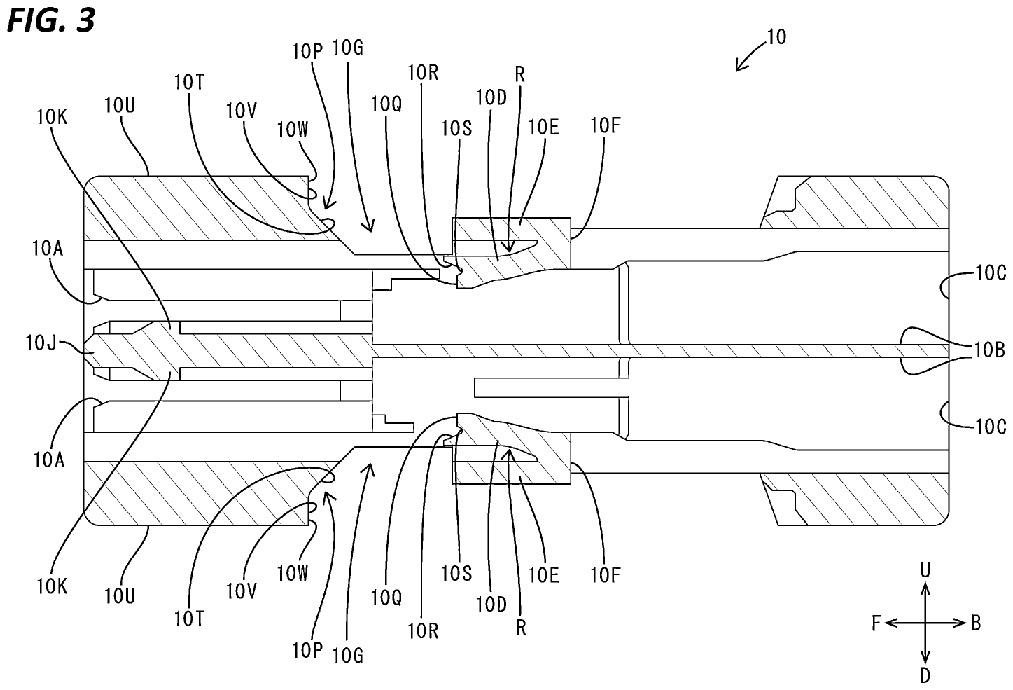

The housing 10 is made of a synthetic resin. The housing 10 has a block shape. As shown in FIG. 2, the housing 10 has formed in a front portion thereof terminal insertion grooves 10A in which a connecting portion 11A (to be described later) of the conductive member 11 is fitted. In the terminal insertion grooves 10A, two namely, upper and lower rows that are open toward the front and extend in the left-right direction are formed. A sandwiched portion 10J is provided between the upper terminal insertion groove 10A and the lower terminal insertion groove 10A to extend in the right-left direction. As shown in FIG. 3, a front end of the sandwiched portion 10J is provided with engaged portions 10K protruding upward and downward.

In a rear end of the housing 10, cavities 10B are arranged in two, upper and lower, rows and aligned in the up-down and left-right directions, and female terminals 12 which will be described later, are fitted into the cavities 10B. A rear end of each cavity 10B is open in the rear end surface of the housing 10 as a terminal insertion opening 10C. Each cavity 10B is provided with a lance 10D. The lance 10D is formed to be elastically deformable and extends forward in a cantilever manner of. The lances 10D are disposed at the upper sides of the upper cavities 10B and at the lower sides of the lower cavities 10B.

Each lance 10D has formed at the front end thereof an engagement surface 10Q that engages a female terminal 12 and a release surface 10R that, releases the engagement of the lance 10D with the female terminal 12 when pressed by a jig G, which will be described later. In each upper lance 10D, the engagement surface 10Q is disposed on the lower side of a front end of the lance 10D. In each upper lance 10D, the release surface 10R is provided on the upper side. In each lower lance 10D, the engagement surface 10Q is disposed on the upper side of the front end of the lance 10D. In each lower lance 10D, the release surface 10R is provided on the lower side. A rearwardly-recessed dent 10S is formed between the release surface 10R and the engagement surface 10Q.

The housing 10 is provided with a pair of upper and lower wall portions 10E that cover the lances 10D. The wall portions 10E have a strip shape with the direction of the plate thickness oriented in the up-down direction, extend in the left-right direction, and are formed on upper and lower side surfaces that intersect the front surface of the housing 10 (see FIG. 2). The upper wall portion 10E covers the upper lances 10D from above. The lower wall portion 10E covers the lower lances 10D from below. The rear ends of the upper lances 10D are coupled to arear end of the upper wall portion 10E. A front portion of the upper wall portion 10E and front portions of the upper lances 10D are vertically spaced apart from each other to define deflection allowance spaces R therebetween. The rear ends of the lower lances 10D are coupled to arear end of the lower wall portion 10E. A front portion of the lower wall portion 10E and front portions of the lower lances 10D are vertically spaced apart from each other to define deflection allowance spaces R therebetween. In other words, the wall portions 10E and the lances 10D define deflection allowance spaces R therebetween. The deflection allowance spaces R allow the lances 10D to deflect therein.

Pairs of upper and lower mounting holes 10F are formed in the upper and lower side surfaces of the housing 10 so as to be open behind the wall portions 10E. The upper mounting holes 10F are in communication with the respective upper cavities 10B and open upward (in the direction intersecting the front-rear direction) (see FIG. 2). The lower mounting holes 10F are in communication with the respective lower cavities 10B and open downward (in the direction intersecting the front-rear direction).

Pairs of upper and lower through holes 10G are formed in the upper and lower side surfaces of the housing 10 so as to be open forward of the wall portions 10E. The upper through holes 10G are in communication with the respective upper cavities 10B and open upward (in the direction intersecting the front-rear direction) (see FIG. 2). The lower through holes 10G are in communication with the respective lower cavities 10B and open downward (in the direction intersecting the front-rear direction). The front edge of each through hole 10G (located forward of the release surface 10R) is connected to an evacuation surface 10T that slopes forward as it approaches an opening 10W in a side surface 10U of the housing 10. The front edge of the evacuation surface 10T is connected to a front end surface 10V extending in the up-down direction toward the side surface 10U of the housing 10. A recess 10P is formed at the front end of the through hole 10G by the evacuation surface 10T and the front end surface 10V. The recess 10P is recessed forward and downward as seen from the side. The engagement surface 10Q of the lance 10D and the release surface 10R are arranged to be oriented toward (facing) the through hole 10G.

As shown in FIG. 2, the left and right side surfaces of the housing 10 have formed thereon pairs of left and right first engagement protrusions 10L, pairs of left and right second engagement protrusions 10M, and pairs of left and right engagement ribs 10N all projecting outward in the left-right direction. FIG. 2 does not show portions of the right first engagement protrusions 10L and the right second engagement protrusions 10M, or the right engagement ribs 10N. The pairs of left and right first engagement protrusions 10L, the pairs of left and right second engagement protrusions 10M, and the pairs of left and right engagement ribs 10N are provided vertically symmetrically on each of the right and left side surfaces of the housing 10. The first engagement protrusions 10L have the functions to guide the retainers 13, which will be described in further details below, when they are moved between a provisional engagement position and a full engagement position, and to retain the retainers 13 in the provisional engagement position and the full engagement position. The second engagement protrusions 10M have the functions to maintain the retainers 13 in the provisional engagement position and the full engagement position. The engagement ribs 10N have the functions to maintain the retainers 13 in the provisional engagement position and the full engagement position.

The upper first engagement protrusions 10L extend obliquely forward and downward. The lower first engagement protrusions 10L extend obliquely forward and upward.

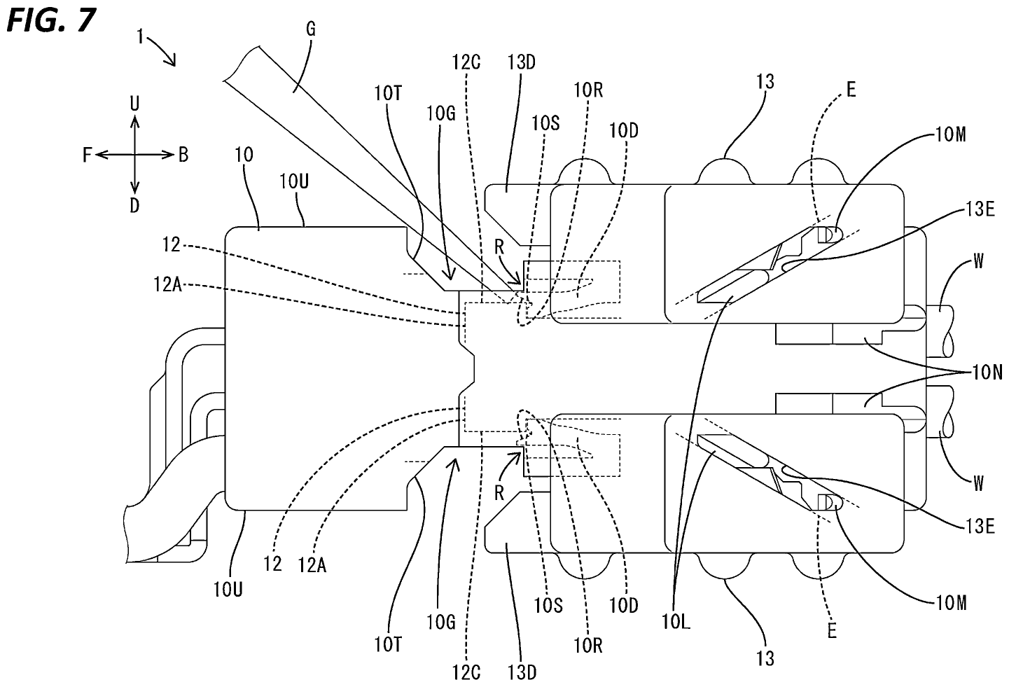

The upper second engagement protrusions 10M are located above and rear of the upper first engagement protrusions 10L and at the top ends of the housing 10. The lower second engagement protrusions 10M are located below and rear of the lower first engagement protrusions 10L and at the bottom ends of the housing 10. Each second engagement protrusion 10M is located on an imaginary extension region E from a first engagement protrusion 10L (see FIG. 7). The engagement ribs 10N are disposed at the rear end of the housing 10. The engagement ribs 10N extend in the front-rear direction. The engagement ribs 10N are located rearward of the first engagement protrusions 10L (see FIG. 7).

### [Configuration of Conductive Member]

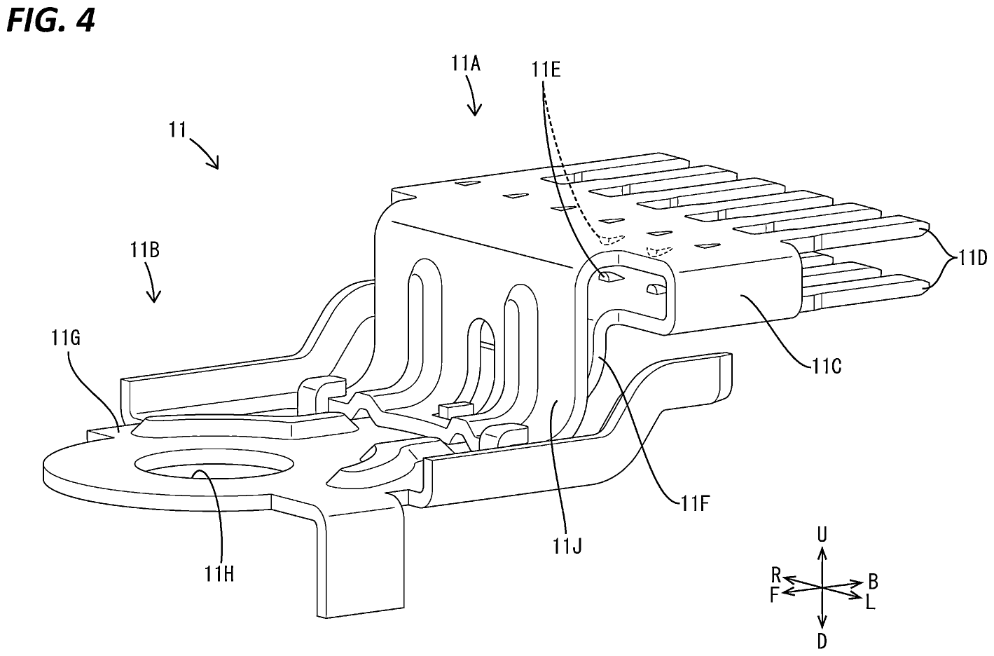

The conductive member 11 is formed by stamping a metal plate. As shown in FIG. 4, the conductive member 11 has a connecting portion 11A and a fastening portion 11B. In the conductive member 11, the fastening portion 11B, which is to be attached to a grounding portion of a vehicle (not shown), is connected to the rear edge of the connecting portion 11A.

The connecting portion 11A includes a belt-like coupling portion 11C bent into a U-shape and a plurality of tabular male terminals 11D arranged at predetermined intervals therebetween to extend rearward from the rear edge of the coupling portion 11C. The intervals between laterally adjacent male terminals 11D are the same as the intervals between laterally adjacent cavities 10B. The interval between the upper portion of the coupling portion 11C that forms one leg of the U-shape and the lower portion of the coupling portion 11C that forms the other leg of the U-shape is the same as the interval between vertically adjacent cavities 10B. Formed on the lower surface of the upper portion of the coupling portion 11C and on an upper surface of the lower portion of the coupling portion 11C is a plurality of engagement protrusions 11E protruding vertically toward each other.

The fastening portion 11B has a first cover portion 11F serving as a cover portion, a second cover portion 11J serving as a cover portion, and a mounting portion 11G. The first cover portion 11F is coupled to the front edge of the lower portion of the connecting portion 11C and bent and extend downward. The second cover portion 11J is coupled to the front edge of the upper portion of the connecting portion 11C and bent and extend downward. The second cover portion 11J is disposed to cover the first cover portion 11F from the front. The mounting portion 11G is bent and extend rearward from the lower edge of the first cover portion 11F. The lower end of the second cover portion 11J is coupled to an upper surface of the mounting portion 11G. The mounting portion 11G has a through hole 11H extending through in the thickness direction. A stud bolt provided in a vehicle (not shown) is passed through the through hole 11H.

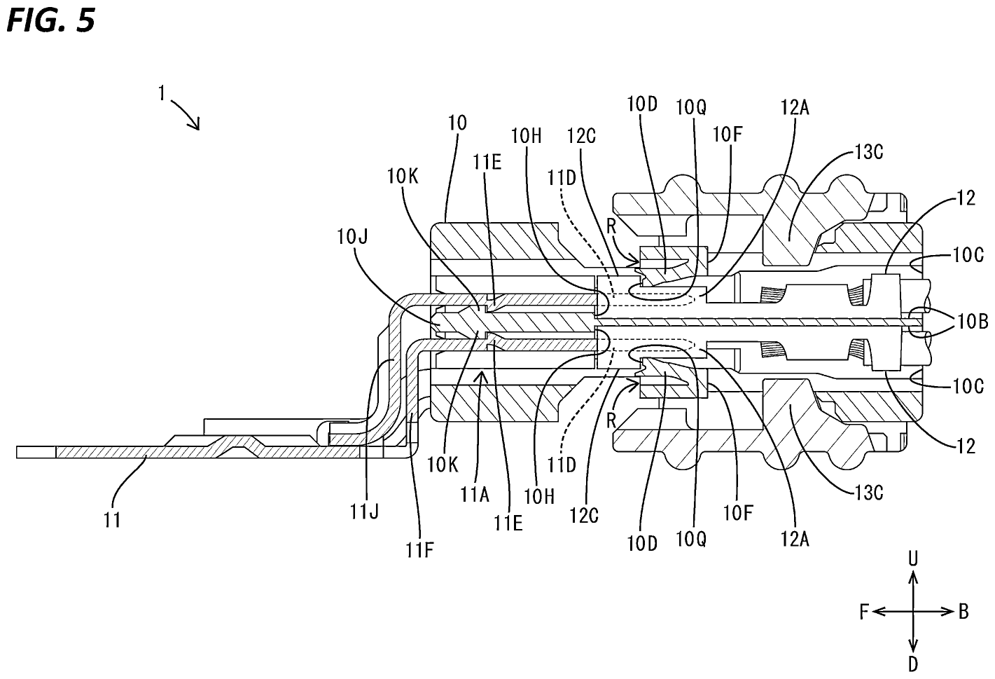

When inserting the connecting portion 11A of the conductive member 11 into the terminal insertion grooves 10A of the housing 10, the male terminals 11D is held to protrude rearward and the connecting portion 11A is then inserted into the terminal insertion grooves 10A from the front. Subsequently, the engagement protrusions 11E ride over the engaged portions 10K of the sandwiched portion 10J in the rearward direction. As a result, the engagement protrusions 11E engage the engaged portions 10K from behind to prevent the connecting portion 11A from slipping out (see FIG. 5). In this way, the conductive member 11 is mounted to the front portion of the housing 10.

Subsequently, the male terminals 11D enter the respective cavities 10B from the front (see FIG. 5). The first cover portion 11F and the second cover portion 11J of the fastening portion 11B are positioned to cover the lower portion of the front surface of the housing 10 from the front side of the housing 10 (see FIG. 5).

### [Configuration of Female Terminal]

The female terminals 12 constitute a part of the conductive member 11. The female terminals 12 are formed by stamping a metal plate. As shown in FIG. 1, each female terminal 12 has a quadrangular tubular portion 12A formed in a quadrangular tube shape and extending in the front-rear direction, and a barrel portion 12B connected to the rear of the quadrangular tubular portion 12A and to which an electric wire W is crimped. The female terminal 12 is inserted into a cavity 10B through the terminal insertion opening 10C and pushed in while elastically deforming the lance 10D. When the female terminal 12 is abutted against the abutment portion 10H provided at a front end of the cavity 10B, the lance 10D returns elastically to its original state and the engagement surface 10Q opposes and engages with the abutment 12C provided on a top surface of the quadrangular tubular portion 12A from behind (see FIG. 5). Thus, the female terminal 12 is primarily engaged and retained by the lance 10D and is received in the cavity 10B formed at the rear of the housing 10.

### [Configuration of Retainer]

The two retainers 13 are made of a synthetic resin. The two retainers 13 retain the female terminals 12 by secondarily engaging with the rear ends of the quadrangular tubular portions 12A of the female terminals 12 inserted in the cavities 10B. Each retainer 13 is attached to the housing 10 movably between the provisional engagement position and the full engagement position, which is obliquely behind the provisional engagement position. The retainer 13 is moved in a direction obliquely intersecting the direction in which the female terminals 12 are inserted (i.e., the front-rear direction).

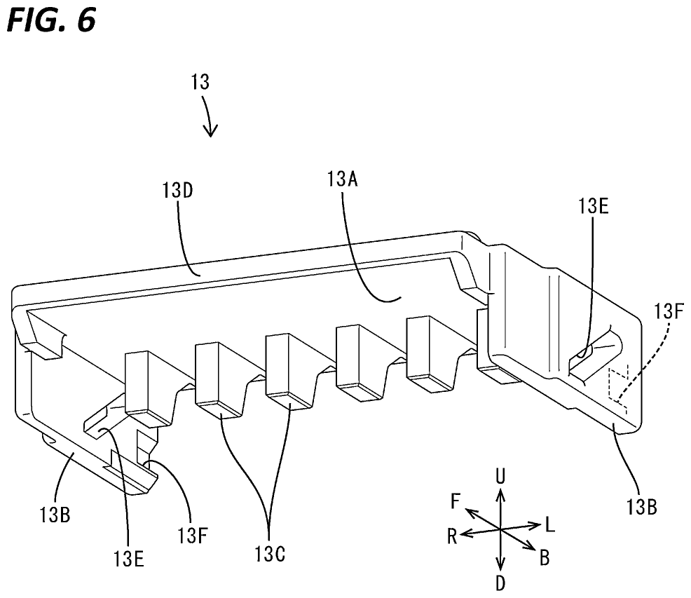

The two retainers 13 are identically configured and differ only in the orientation of attachment to the housing 10. Therefore, the configuration of the upper retainer 13 will be described below while omitting the description of the lower retainer 13. As shown in FIG. 6, the retainer 13 includes a flat plate portion 13A, a pair of right and left side plate portions 13B hanging down from the left and right edges of the plate portion 13A, a plurality of engagement portions 13C protruding downward from the lower surface of the plate portion 13A, and an eave portion 13D.

The side plate portions 13B have a flat plate shape with the thickness direction thereof oriented in the left-right direction. Each side plate portion 13B has a guide hole 13E and an engagement recess 13F formed therein. The guide hole 13E is formed to extend through the side plate portion 13B in the thickness direction. The guide hole 13E extends obliquely forward and downward. The engagement recess 13F is recessed outward in arear end of the laterally inner side of the side plate portion 13B. The engagement portions 13C have a flat plate shape with the thickness direction thereof oriented in the left-right direction and are arranged in the left-right direction at predetermined intervals therebetween. The eave portion 13D forms a front portion of the plate portion 13A. In other words, the eave portion 13D extends forward from the engagement portions 13C.

### Example of Assembly of Connector

First, the connecting portion 11A of the conductive member 11 is attached to the terminal insertion grooves 10A of the housing 10 from the front.

Next, a retainer 13 is assembled to the housing 10. In particular, the side plate portions 13B are held in parallel with the left and right side walls of the housing 10, and the plate portion 13A is brought over the top wall of housing 10 (see FIG. 1). Then, the retainer 13 is brought close to the housing 10 from above, and as shown in FIG. 7, the first engagement protrusions 10L and the second engagement protrusions 10M of the housing 10 are fitted in the guide holes 13E. At this point, the first engagement protrusions 10L come into contact with lower edges of the guide holes 13E of the retainer 13, and the second engagement protrusions 10M come into contact with upper edges thereof. As a result, the retainer 13 is restricted from moving relative to the housing 10. At this point, the retainer 13 is in the provisional engagement position. The lower ends of the engagement portions 13C are disposed in the mounting holes 10F (see FIG. 5).

Next, the female terminals 12 are attached to the cavities 10B of the housing 10 from behind. At this point, the male terminals 11D of the connecting portion 11A of the conductive member 11 are inserted into the quadrangular tubular portions 12A of the female terminals 12 from the front, connecting the female terminals 12 with the conductive member 11 (see FIG. 5).

With the retainer 13 set in the provisional engagement position, the eave portion 13D is positioned to cover the rear portions of the through holes 10G of the housing 10 from above. As such, front portions of the through holes 10G are upwardly open. To pull out a female terminal 12, the jig G is inserted into the through hole 10G of the housing 10 from a direction that intersects the front-rear direction to upwardly press against the release surface 10R of the lance 10D, thus releasing the engagement of the lance 10D with the female terminal 12. Specifically, with the lance 10D engaging the abutment 12C of the quadrangular tubular portions 12A, the jig G is brought into contact with the release surface 10R formed in the front end of the lance 10D to press the release surface 10R, causing the lance 10D to elastically deform to allow the lance 10D to enter the deflection allowance space R. In this way, the engagement of the lance 10D with the female terminal 12 is released so that the female terminal 12 can be pulled out of the cavity 10B. It should be noted that due to the tip of the jig G entering the dent 10S, a sufficient area of contact (amount of engagement) of the jig G with the release surface 10R is secured, so that the jig G is not easily detached from the release surface 10R. Further, as the evacuation surface 10T slopes forward and away from the release surface 10R as it approaches the opening 10W in the side surface 10U, the evacuation surface 10T is not likely to obstruct the action of the jig G on the release surface 10R.

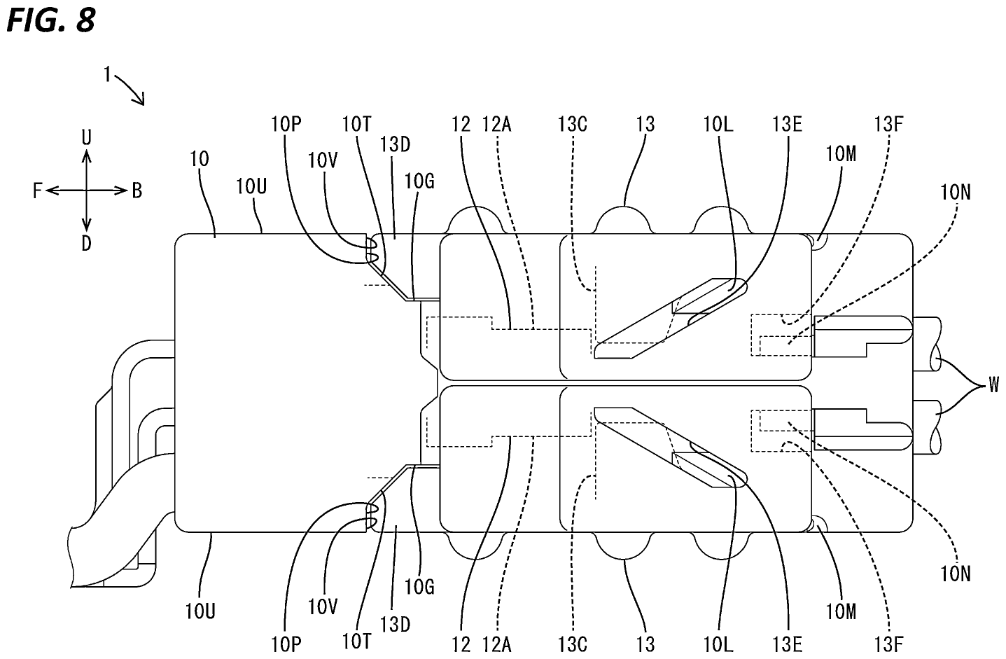

Next, subsequent to the insertion of the female terminal 12, the retainer 13 is pulled to move from the provisional engagement position to the full engagement position. At this moment, an actuation force overcoming the engagement force between the upper ends of the guide holes 13E and the second engagement protrusions 10M is applied to the retainer 13 to elastically deform the side plate portions 13B outward in the left-right direction. When the retainer 13 is moved, the second engagement protrusions 10M are detached from the guide holes 13E while the first engagement protrusions 10L remains fitted in the guide holes 13E (see FIGS. 7 and 8). As a result, the retainer 13 is translated along the path of movement through the guide holes 13E.

When the retainer 13 reaches the full engagement position, as shown in FIG. 8, the upper edges of the guide holes 13E come into contact with the first engagement protrusions 10L and the engagement ribs 10N enter the engagement recesses 13F, thereby holding the retainer 13 in the full engagement position. As the engagement portions 13C are disposed in the mounting holes 10F to secondarily engage the quadrangular tubular portions 12A of the corresponding female terminals 12 from behind, the retainer 13 retains all the female terminals 12. That is, the female terminals 12 are securely held in place and retained by the primary engagement by the lances 10D and the secondary engagement by the retainer 13.

Once the retainer 13 is held in the full engagement position, a front end of the eave portion 13D of the retainer 13 is disposed in the recesses 10P to close the through holes 10G. At this moment, the front end of the eave portion 13D opposes the evacuation surfaces 10T and the front end surfaces 10V from behind. With the retainer 13 in the full engagement positions, the eave portion 13D covers the through holes 10G of the housing 10 from above. As such, the jig G is prevented from entering any of the through holes 10G to release the engagement of the lance 10D. As the lower retainer 13 is flipped to a vertically inverted position with respect to the upper retainer 13 and attached to the housing 10 from below, the description of its attachment is omitted.

Each retainer 13 can be moved also from the full engagement position to the provisional engagement position. That is, the retainers 13 are capable of moving with respect to the housing 10 between the provisional engagement position and the full engagement position. In this case, as the retainer 13 is moved in the rearward direction from the full engagement position to the provisional engagement position, the eave portion 13D also moves in the rearward direction to upwardly (downwardly) open the front portion of the through holes 10G (see FIG. 7).

The following describes the operation of the first embodiment.

The connector 1 includes a housing 10, a conductive member 11, female terminals 12, and retainers 13. The conductive member 11 is mounted to the front portion of the housing 10. The female terminals 12 are received in the rear portion of the housing 10 and connected to the connecting portion 11A of the conductive member 11. The retainers 13 are movably disposed between a provisional engagement position and a full engagement position with respect to the housing 10. The conductive member 11 includes a first cover portion 11F and a second cover portion 11J that cover the front surface of the housing 10. The housing 10 includes lances 10D, deflection allowance spaces R, wall portions 10E, mounting holes 10F, and through holes 10G. Each lance 10D is capable of elastic deformation to primarily engage a female terminal 12. The deflection allowance space R allows the lance 10D to deflect therein. The wall portions 10E are formed including the upper and lower side surfaces that intersect the front surface and define the deflection allowance spaces R between the lances 10D and the deflection allowance spaces R. The mounting holes 10F are open in the upper and lower side surfaces rearward of the wall portions 10E. The through holes 10G are open in the upper and lower side surfaces forward of the wall portions 10E. The retainers 13 include the engagement portions 13C disposed in the mounting holes 10F for secondarily engaging the female terminals 12 in the full engagement position. The lances 10D each have a release surface 10R disposed to be oriented toward the through hole 10G.

According to this configuration, as the through holes 10G can be formed to be open in the upper and lower side surfaces that intersect the front surface, the lances 10D can be manipulated with a jig via the through holes 10G even if the conductive member 11 is configured to cover the front surface of the housing 10 so that the jig cannot be inserted from the front surface. Moreover, as the through holes 10G and the mounting holes 10F are open in the upper and lower side surfaces that intersect the front surface, the through holes 10G and the mounting holes 10F can be both formed using a single slide core in the mold without requiring a complicated mold structure.

Each retainer 13 has an eave portion 13D extending forward from the engagement portions 13C, and the eave portion 13D closes the through holes 10G in the full engagement position and opens the through holes 10G in the provisional engagement position. This configuration can limit and permit the release of the engagement of the lances 10D.

Each retainer 13 moves obliquely rearward from the full engagement position to the provisional engagement position. According to this configuration, with the retainer 13 in the provisional engagement position, the eave portion 13D can leave open the front portions of the through holes 10G, facilitating the insertion of the jig G in the through holes 10G in a direction that intersects the front-rear direction.

Each through hole 10G has an evacuation surface 10T forward of the release surface 10R that slopes forward as it approaches an opening 10W in a side surface 10U. According to this configuration, the evacuation surfaces 10T provide a freedom in the insertion of the jig G into the through holes 10G. Moreover, the jig G can act on the release surfaces 10R without interference with the evacuation surfaces 10T.

### Other Embodiments

The embodiments disclosed herein should be considered in all respects only to be illustrative and not restrictive. The scope of the present invention is not limited to the embodiments disclosed herein and indicated by the claims, and all changes which come within the scope of equivalency of the claims are intended to be encompassed therein.

Unlike the first embodiment, a single retainer may be attached to the housing.

Unlike the first embodiment, left and right side surfaces that intersect the front surface of the housing may be formed as the wall portions.

Unlike the first embodiment, male terminals with tabs may be used as the terminals and female terminals may be used as the connecting portion.

Unlike the first embodiment, the retainers may be configured to move in the front-rear direction rather than moving obliquely relative to the front-rear direction.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
housing;
a conductive member mounted to a front portion of the housing;
a terminal housed in a rear portion of the housing to be connected to a connecting portion of the conductive member; and
a retainer disposed capable of moving between a provisional engagement position and a full engagement position with respect to the housing;
wherein the conductive member includes a cover portion covering at least a part of a front surface of the housing;
wherein the housing includes a lance capable of elastic deformation for primarily engaging the terminal, a deflection allowance space for allowing the lance to deflect therein; a wall portion formed on a side surface that intersects the front surface and defines the deflection allowance space between the lance and the wall portion, a mounting hole open in the side surface rearward of the wall portion, and a through hole open in the side surface forward of the wall portion;
wherein the retainer includes an engagement portion disposed in the mounting hole for secondarily engaging the terminal in the full engagement position; and
wherein the lance includes a release surface disposed to be oriented toward the through hole.

2. The connector according to claim 1, wherein the retainer includes an eave portion extending forward from the engagement portion, and
the eave portion closes the through hole in the full engagement position and opens the through hole in the provisional engagement position.

3. The connector according to claim 2, wherein the retainer moves rearward from the full engagement position to the provisional engagement position.

4. The connector according to claim 1, wherein the through hole has an evacuation surface forward of the release surface, the evacuation surface sloping forward as the evacuation surface approaches the opening in the side surface.
